(19) United States
(12) Patent Application Publication
(10) Pub. No.: US 2014/0344058 A1
(43) Pub. Date: Nov. 20, 2014

(54) SYSTEMS AND METHODS FOR DISTRIBUTED MARKETING AUTOMATION

(71) Applicant: Fision Holdings, Inc., Minneapolis, MN (US)

(72) Inventor: Michael Brown, Minneapolis, MN (US)

(73) Assignee: Fision Holdings, Inc, Minneapolis, MN (US)

(21) Appl. No.: 14/211,150

(22) Filed: Mar. 14, 2014

Related U.S. Application Data
(60) Provisional application No. 61/800,523, filed on Mar. 15, 2013.

(51) Int. Cl. G06Q 30/02; G06F 17/28

(52) U.S. Cl. CPC G06Q 30/0261; G06F 17/289
USPC 705/14.58

(57) ABSTRACT

A computerized system and method provides for managing and using marketing assets across an enterprise. A network interface may communicate with a first client machine associated with a first user having a first language and a second client machine associated with a second user having s second language. An electronic data storage may store a marketing asset in a marketing asset language. A processor may cause a graphical user interface to be displayed on the first client machine in the first language and the marketing asset to be displayed with respect to the graphical user interface only when the marketing asset language corresponds to the first language, and cause the graphical user interface to be displayed on the second client machine in the second language and the marketing asset to be displayed with respect to the graphical user interface only when the marketing asset language corresponds to the second language.

### PRIORITY

This application claims the benefit of priority to U.S. Provisional Application No. 61/800,523, “SYSTEMS AND METHODS FOR DISTRIBUTED MARKETING AUTOMATION,” filed Mar. 15, 2013, which is incorporated by reference herein in its entirety.

### TECHNICAL FIELD

This application relates generally to data processing within a network-based integrated document and workflow management system, and more specifically to systems and methods for distributed marketing automation.

### BACKGROUND

The efficient and systematic management and use of marketing assets can be exceptionally difficult for organizations of varying size and complexity. Certain organizations may have some or all of many sales people or employees generally, many geographic locations, many products or services, many channels/partners, many brands, many marketing assets, many brand control requirements, and/or many compliance requirements. The sharing and formatting of marketing assets may be made more challenging by organizational complexities and localization requirements.

### BRIEF DESCRIPTION OF THE DRAWINGS

Some embodiments are illustrated by way of example and not limitation in the figures of the accompanying drawings in which:

FIGS. 1-1 to 1-4 illustrate an overview of a distributed marketing automation system use interfaces and systems, according to an example embodiment.

FIGS. 2-1 to 2-24 illustrate systems and methods for automated distributed marketing, according to example embodiments.

FIG. 3 illustrates an environment for operating a mobile device, according to an example embodiment.

FIG. 4 is a block diagram illustrating a mobile device, according to an example embodiment.

FIG. 5 is a block diagram illustrating a network-based system for managing marketing assets and interacting with administrators and users according to an example embodiment.

FIG. 6 is a diagrammatic representation of a machine in the example form of a computer system within which a set of instructions for causing the machine to perform any one or more of the methodologies discussed herein may be executed.

### DETAILED DESCRIPTION

Example systems and methods for providing distributed marketing automation are described. In the following description, for purposes of explanation, numerous specific details are set forth in order to provide a thorough understanding of example embodiments. It will be evident, however, to one skilled in the art that the present invention may be practiced without these specific details. It will also be evident that distributing marketing automation solutions are not limited to the examples provided herein, and may include other scenarios not specifically discussed.

The following terms are used herein, and should be interpreted in accordance with the following definitions and other definitions understood by those of skill in the art for the same term, provided that such other definitions are not inconsistent with the definitions given herein.

### Admin

Admin is a title given to users with Administrative capabilities in the Distributed marketing automation system. Admins have the ability to edit user permissions, utilize Login As functionality and have a greater level of access to contents of the Asset Library.

### Asset

An asset is an umbrella term that refers to any digital file that can be used in internal or external communications efforts. Major types of assets used in distributed marketing automation include text, image, PDF, video, audio, podcasts. Any of a variety of media file types (e.g., JPG, DOC, MPEG, etc.) can be used as an asset. Assets are saved in and accessed from the Asset Library.

### Asset Groups

Asset Groups allow admin users to manage which sets of assets a user is allowed to access when they customize emails or other materials. Users can belong to one or multiple Asset Groups.

### Asset Group Admin

Asset Groups is an organizational function to help manage how assets are stored and who can access them. This page allows a company admin to add, remove or rename the company asset groups.

### Asset Library

At least some, and in various examples all assets are stored in the Asset Library on either the provider side, the client side, or both with the user of APIs. Multiple discrete Asset Libraries may be accessed and/or considered to be part of a unitary whole Asset Library.

### Client ID

The client ID is an optional informational assignment given to assets to assist in identifying and narrowing the search for assets.

### Login Hierarchy

The Login Hierarchy refers to the user's place within the company tree of system permissions. In an example, employees/users are grouped beneath their supervisor, among other potential hierarchical relationships. Groups are nested hierarchically, meaning a head of the organization is at the top of the hierarchy and subordinates follow according to rank.

### Custom Dictionary

The Custom Dictionary allows a user to add words into the system that are specific to a company and may not be recognized in an dictionary (English or non-English). These words may be brand names or product offerings, etc.

### Expiration Date

Users can activate and set expiration dates for some or all assets to determine when they will be accessible to users in the system. If a user has used or downloaded an asset that has since expired, the user may receive a pop-up message informing them that the asset has expired and should or must agree to discontinue using the asset.

### Image Assets

Image Assets are files saved as images for use in email or template form customization. These assets may make up the sections of the template zones to which they are assigned. File types can include but are not limited to JPG, GIF, PDF, PNG and EPS.

### Image Info

Image Info displays basic information about the asset including its ID, Title, Content, expiration dates and Text Asset type. This Image Info may comprise the asset and determine how it is used in a template.

### Keyword(s)

By default, keywords are used in filtering both template options and Asset library searches. Keywords may be assigned to assets, such as for the simplification of organization and searching Keywords are may be organized in groups to assign an asset to multiple related keywords. A Keywords tab allows for the management of keywords associated with some or all of the assets.

### Keyword Admin

The Keyword Admin section may allow the admin to edit categories and keywords. Changes made in Keyword Admin may be global.

### Login As

The Login As functionality allows an admin to login as a user. The Login As function may allow the admin to monitor activity or operate the selected user's account as the user.

### Organization Hierarchy

The Organization Hierarchy is a list of users (indirect and direct) grouped according to a sales, marketing and/or operations process. Users are grouped beneath (in subordinate position to) their respective hierarchy. The list is nested, so the list may show or may be expanded to show independent or direct reports of each user.

### Print Vendors

Print Vendor information may be stored for use in Print-on-Demand orders. Print Vendors may reflect preferred printers or other printers that have been incorporated into the system.

### Print Vendor Admin

Print Vendor Admin has the ability to add or edit Print Vendor information stored in the system for user orders. Vendors entered may be displayed as options for order fulfillment in the My Orders section.

### Template(s)

Templates serve as architectural patterns to assist in building communication pieces such as emails and PDFs. Templates may provide a consistent foundational model with designated Template Zones into which various assets can be placed. Templates provide, at least in part, consistency between communication pieces by providing a limited number of specified, customizable variables.

### Template Only

The Template Only preference allows a user to determine if a keyword or category can only be used when filtering assets used in a template. In such an example, the assets may not be available in the asset library.

### Template Zone

Each template has zones assigned to organize asset placement. Assets may be assigned to particular Template Zones. In an example, the assignment of an asset to a particular Template Zone may provide that only relevant assets are available to users when customizing materials and emails. Zones can be manipulated or reorganized by the client customer brand requirements or customer branding requirements.

### Text Asset

Text Assets are any text materials. This includes headers, greetings and articles. These assets may be accessed by users in templates when customizing emails or PDFs to make up the pieces of the template zones to which they are assigned.

### Text Type

Text type identifies the nature/type of text of which a text asset is comprised. This can be any kind of text, including greetings, articles, headers, body copy, calls to action, secondary copy, etc. Text type assists in locating and placing the appropriate type of text in template zones.

### User Admin

The User Admin function allows administrators to search for any user in the company or organization. This function allows admins to edit or review user information, user roles, asset groups or the user's place in the Company Login Hierarchy.

### User Details/User Info

These personal and contact details will be used to populate fields in custom email and PDF templates.

### User Roles

Each user in the system must be assigned a user role. This will determine their permissions and capabilities throughout the system.

### System

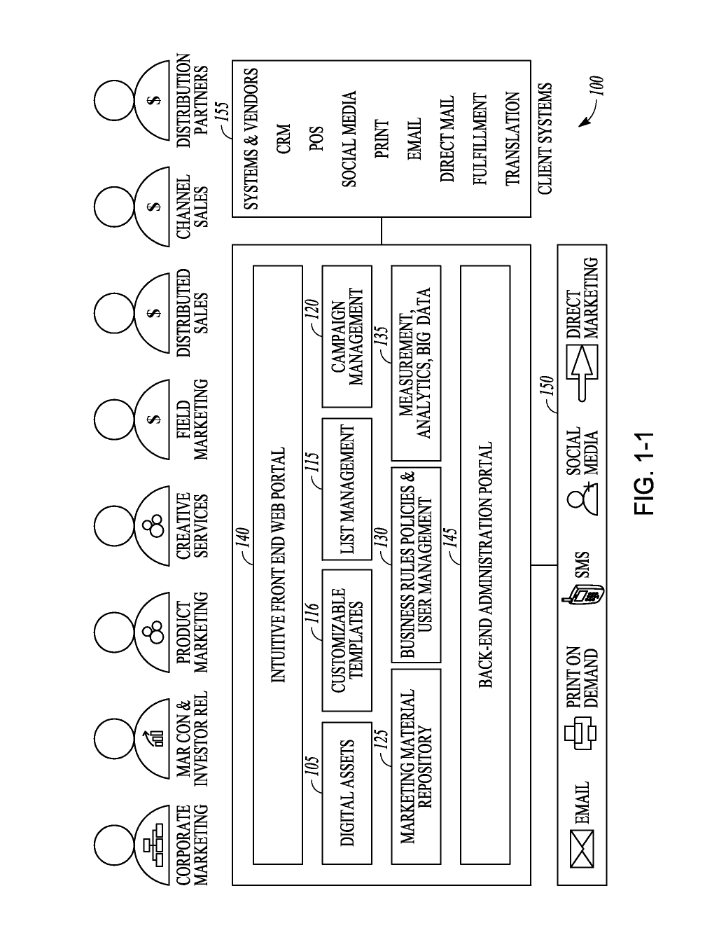

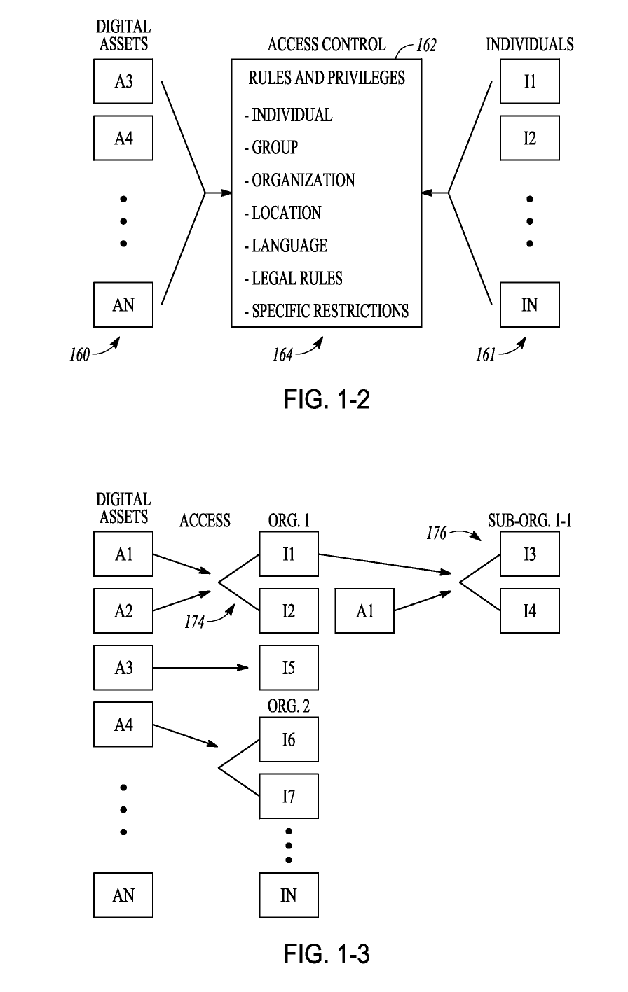

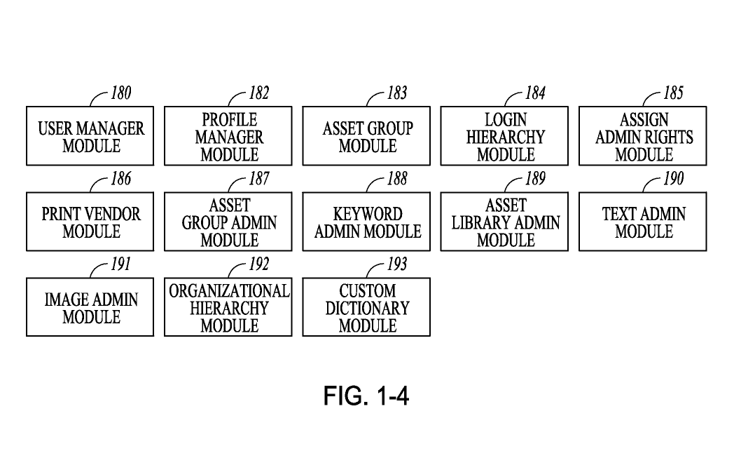

Referring now to FIG. 1-1, there is illustrated an overview of a distributed marketing automation system according to one example embodiment. System 100 includes one or more data structures and computer programs to hold, store, manipulate, display and other use various kinds of data used to automate various asset management, authoring and distribution tasks. In one example embodiment, data structures and programs are represented by modules that include marketing materials 105, customizable template module 110, list management module 115, campaign management module 120, marketing material depository module 125, business rules, policies, user management module 130, measurement, and analytics and big data module 135.

A front-end web portal 140 provides a graphical user interface for use by various constituencies, including corporate and product marketing personnel, creative services personnel, field marketing personnel, and personnel in distributed sales, channel sales and distribution partners. A back-end administration portal 145 provides access to systems administrators to provide a variety of system configuration functions, as explained herein below.

As described below with respect to the Profile module 182 in FIG. 1-4 and FIG. 2-2, according to one example embodiment, the Profile module 182 has a configurable localization setting for each user that allows the administrator to set the language for the user. When the user logs in, the system is responsive to the localization setting for a user to automatically change the GUI on either the back-end portal 145 and/or the front-end portal 140, depending on which interface the user is accessing, to the language (localization) corresponding to the setting for that user. Accordingly, the system can accommodate users requiring or utilizing different languages. According to another embodiment, marketing assets can be tagged such that only assets matching the user's localization setting may be accessible to that user, as in example embodiment is performed using the privileges of the Asset Groups. For example, the system may preclude a user being added to an Asset Group that contains marketing assets authored in a language different from that of the user.

Further according to one example embodiment, a language translation service, included for example in one of the services 155, translates the graphical user interface language elements of the portals 140 and 145, according to the language/localization setting of the user. According to one example embodiment of this method, the portal display pages are dynamically translated by the language translation service according to a language translation setting supplied to the translation service by the system 100. Alternatively, static page elements may be translated and cached, and updated when modified.

In addition, system 100 connects to a variety of services 150 used to distribute marketing assets, including e-mail, print on demand, SMS text, social media, and direct marketing services. Also, system 100 interfaces with various other systems, vendors and services 155 including customer relationship management systems, point of sales systems, social media systems, print systems, e-mail systems, direct mail systems, fulfillment systems and translation systems.

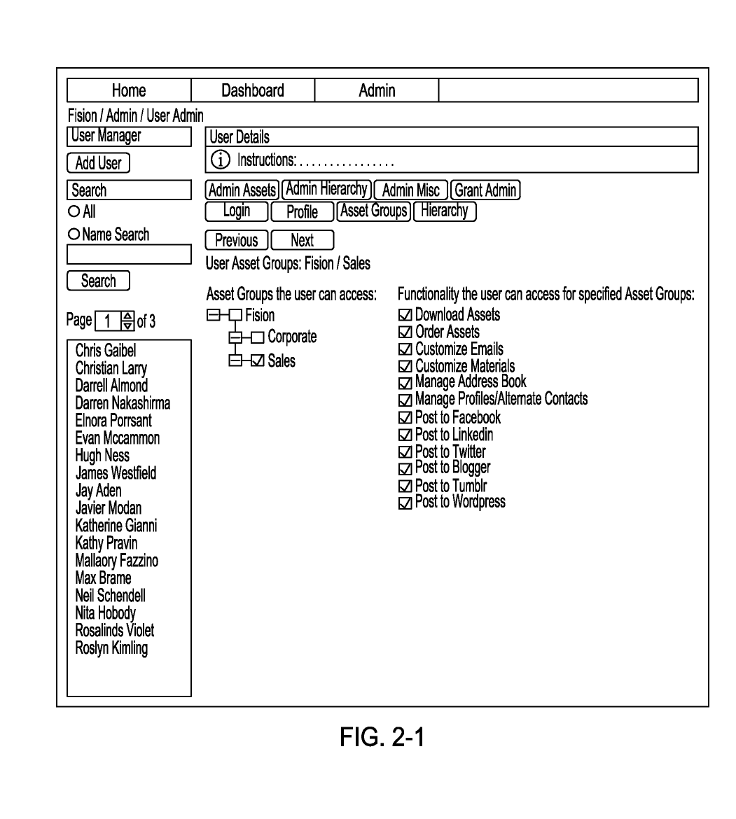

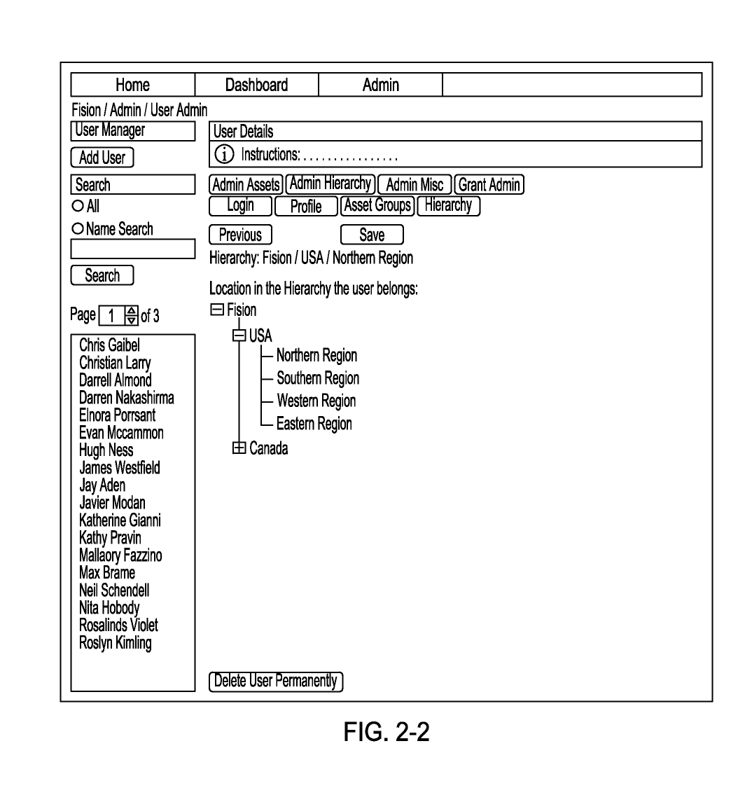

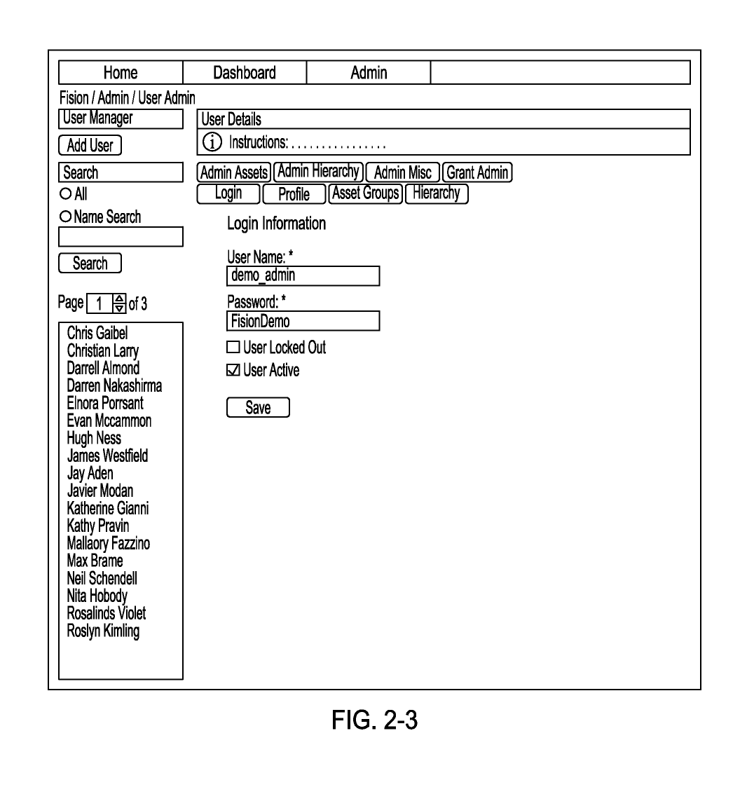

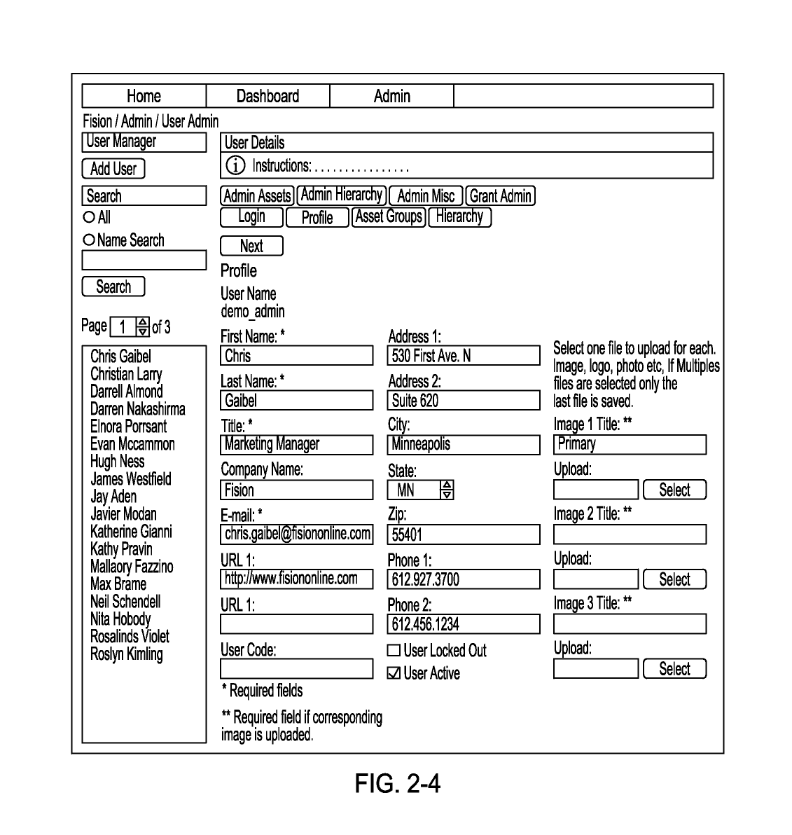

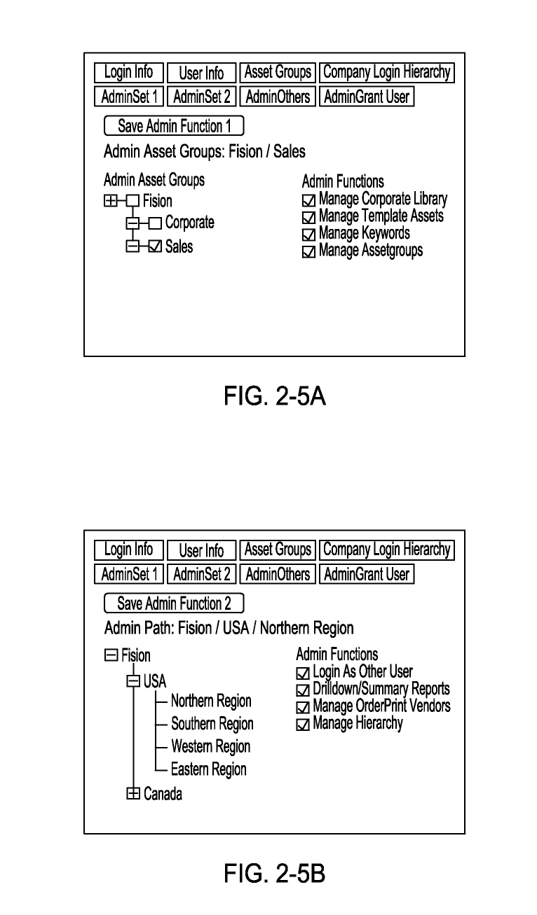

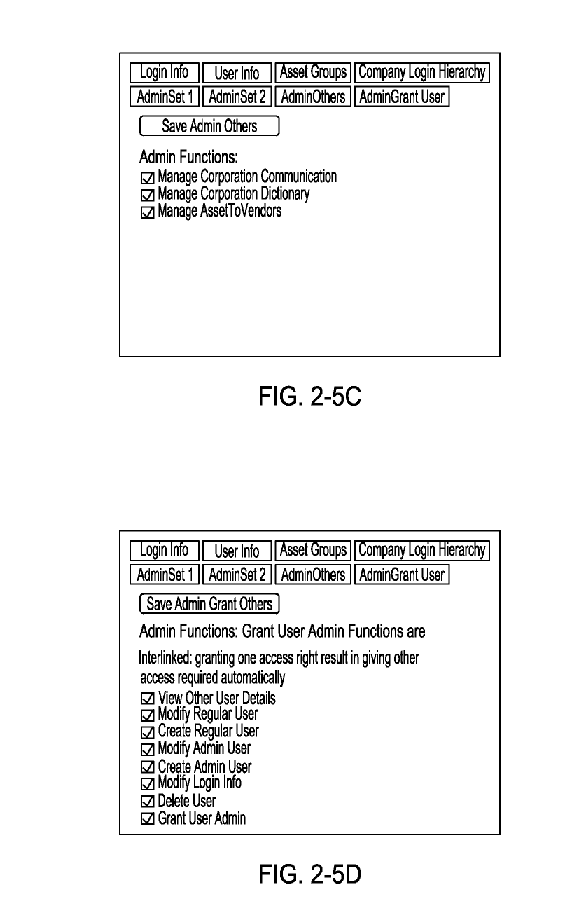

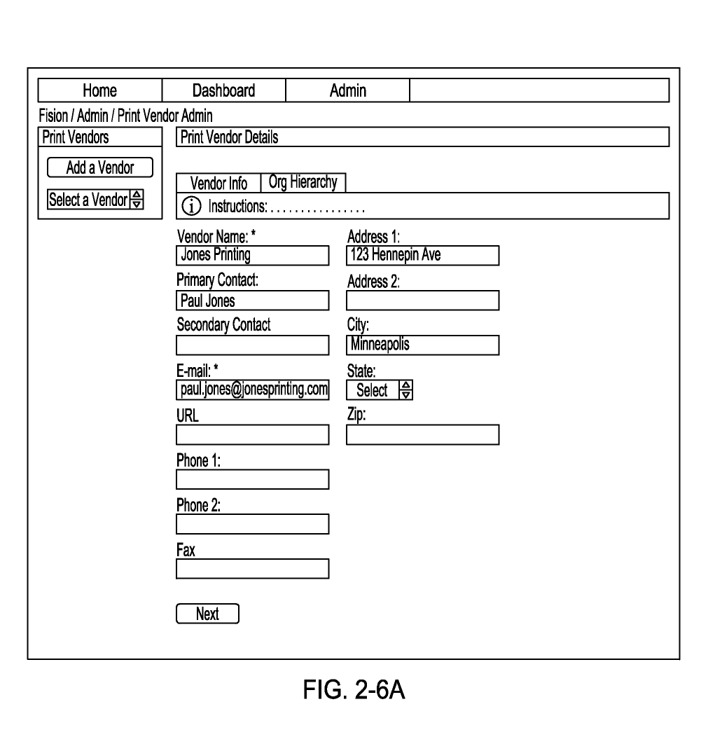

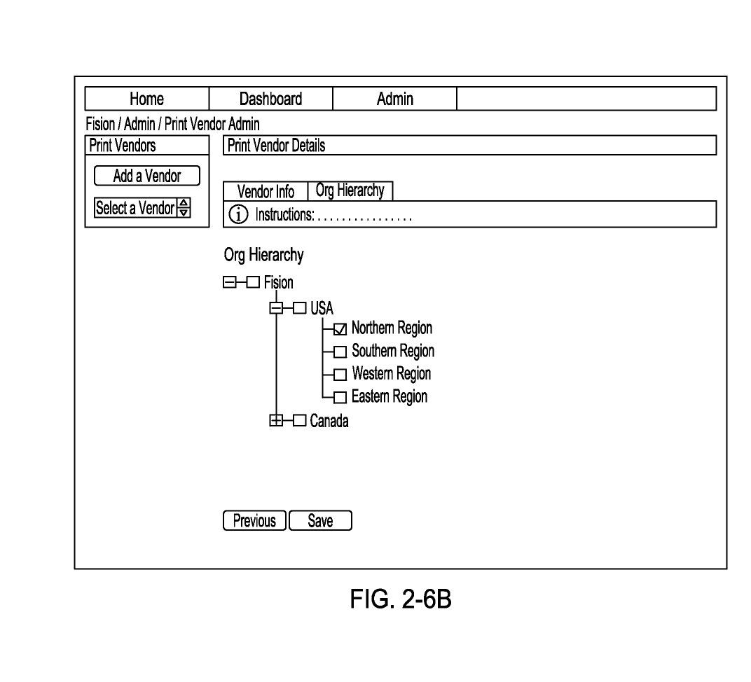

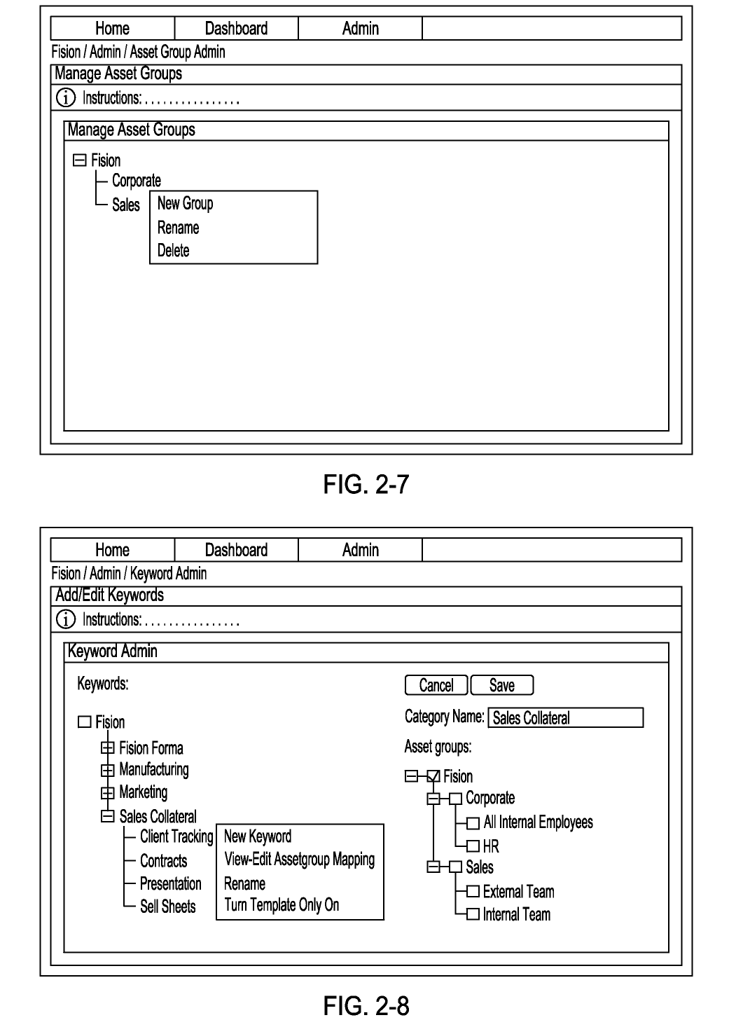

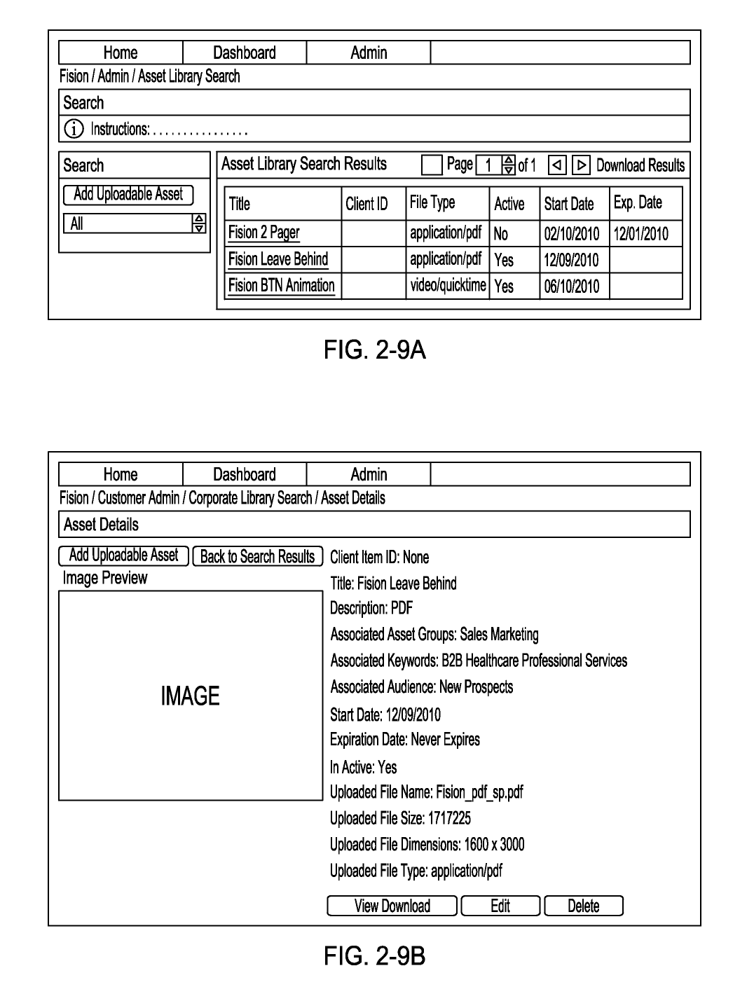

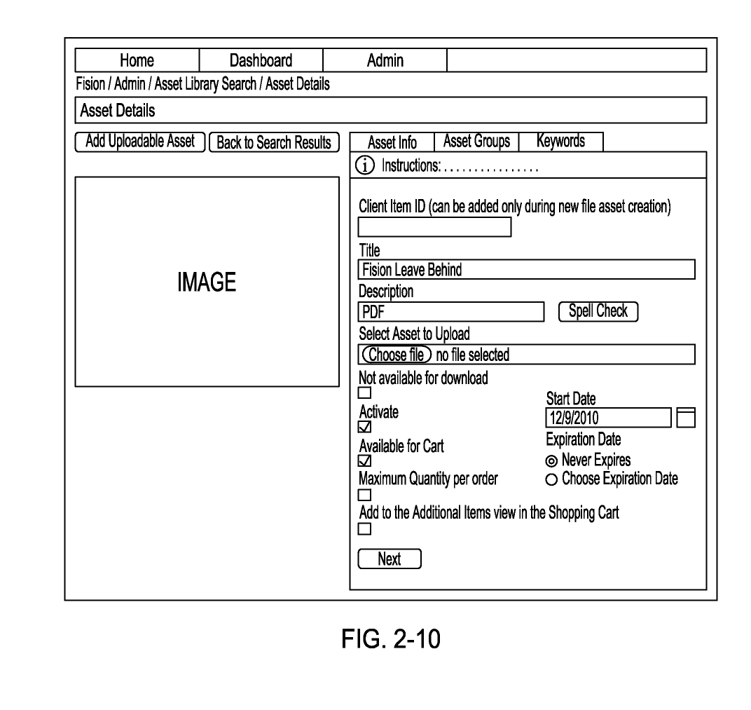

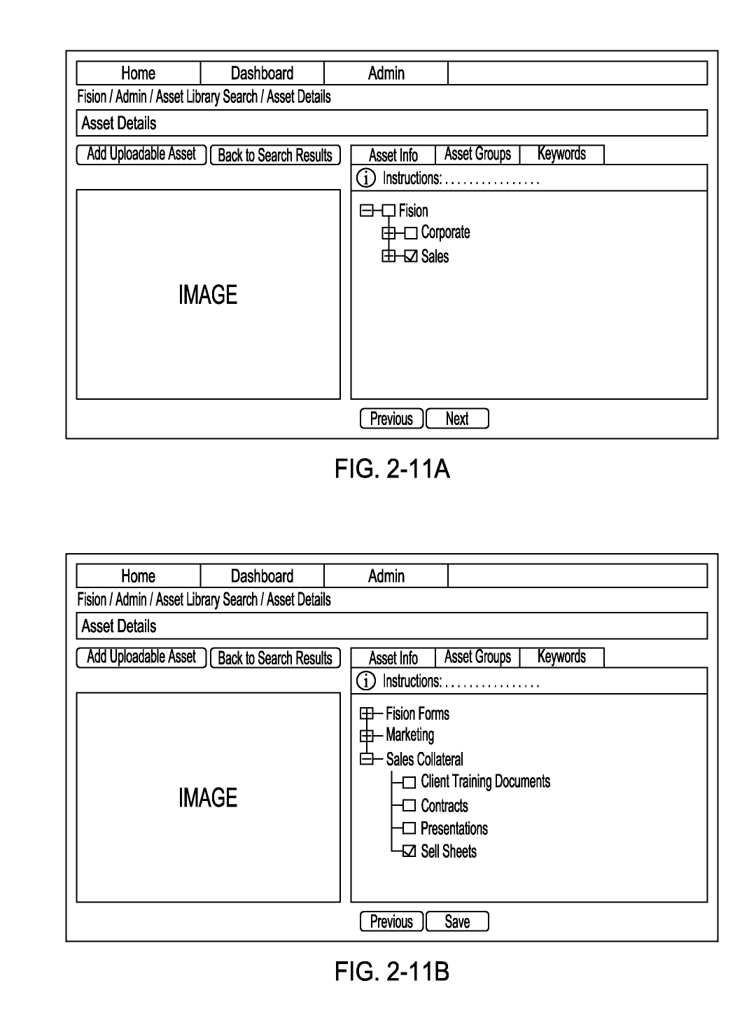

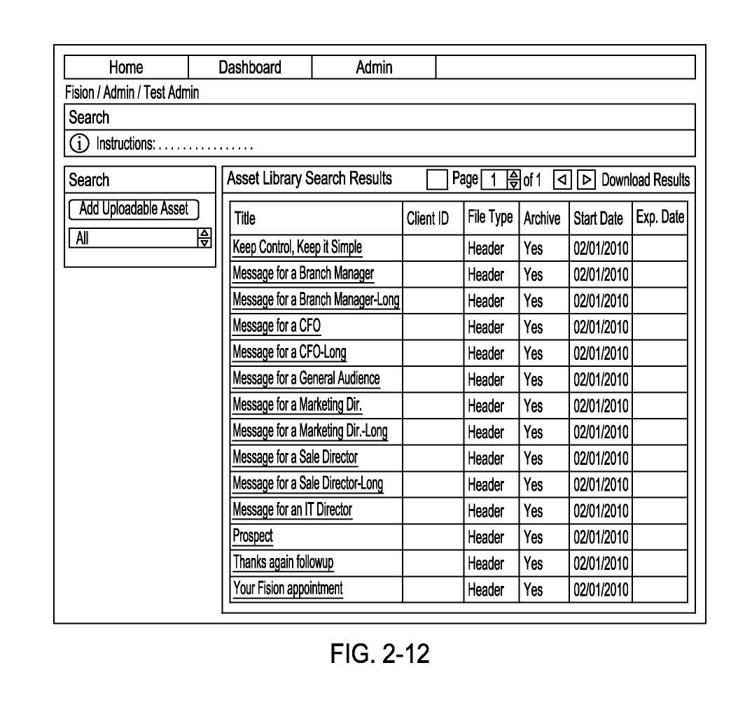

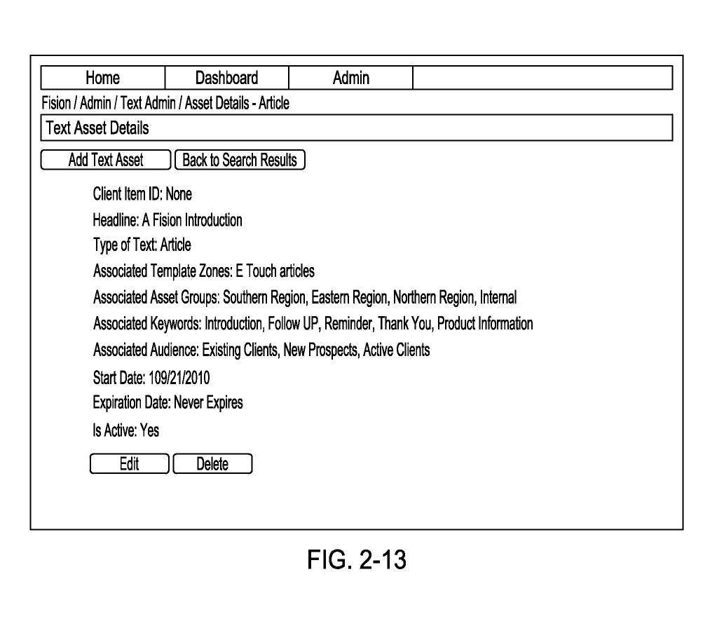

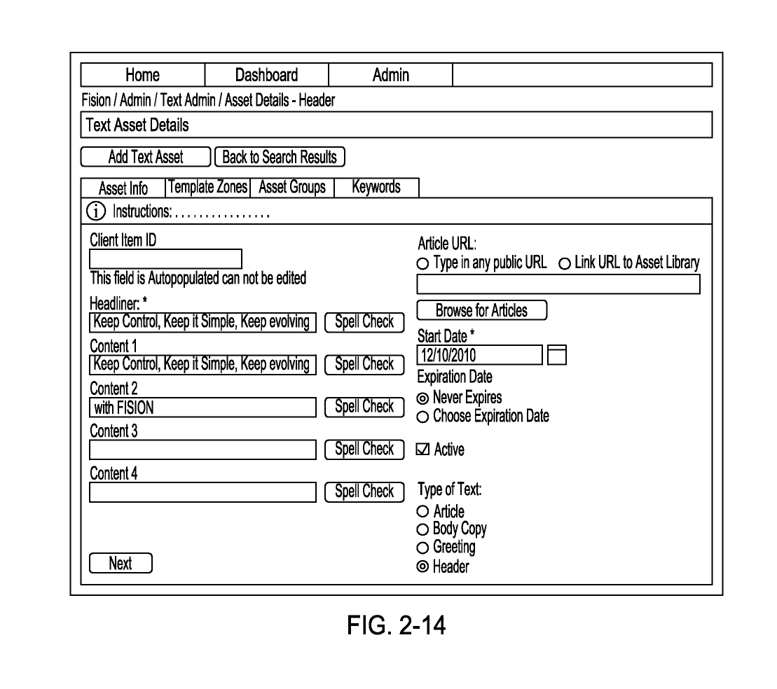

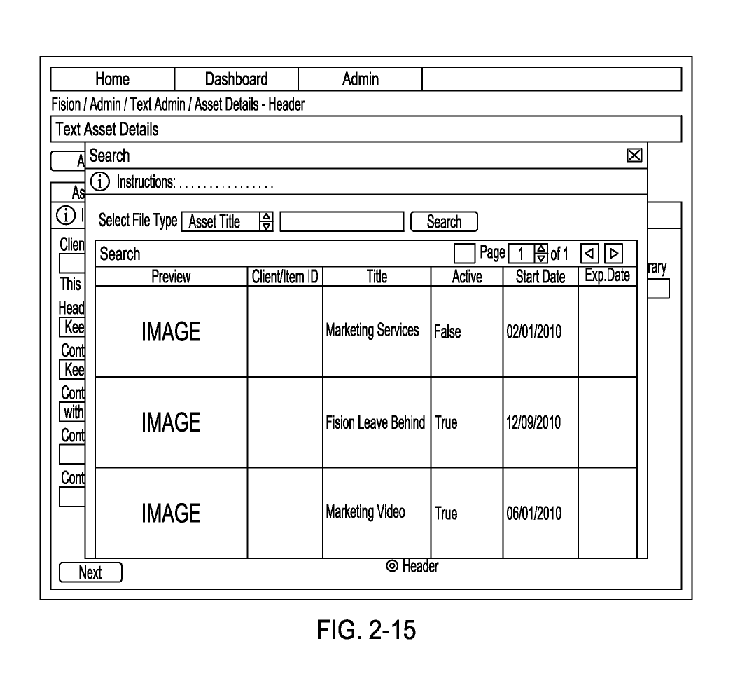

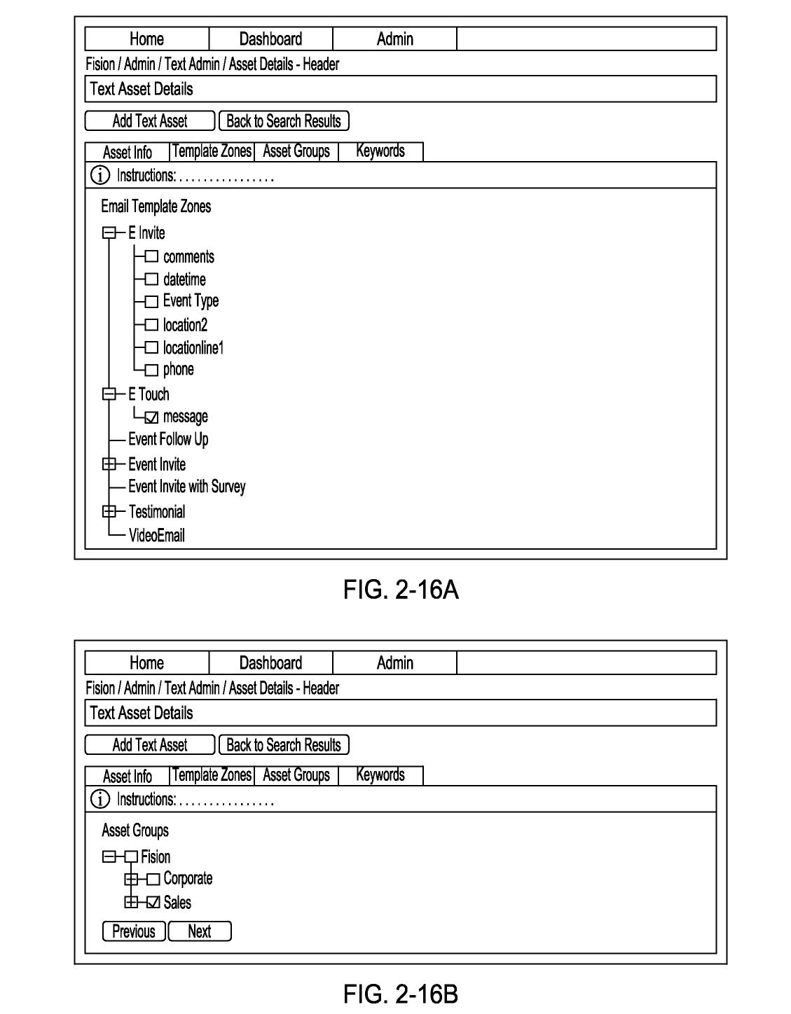

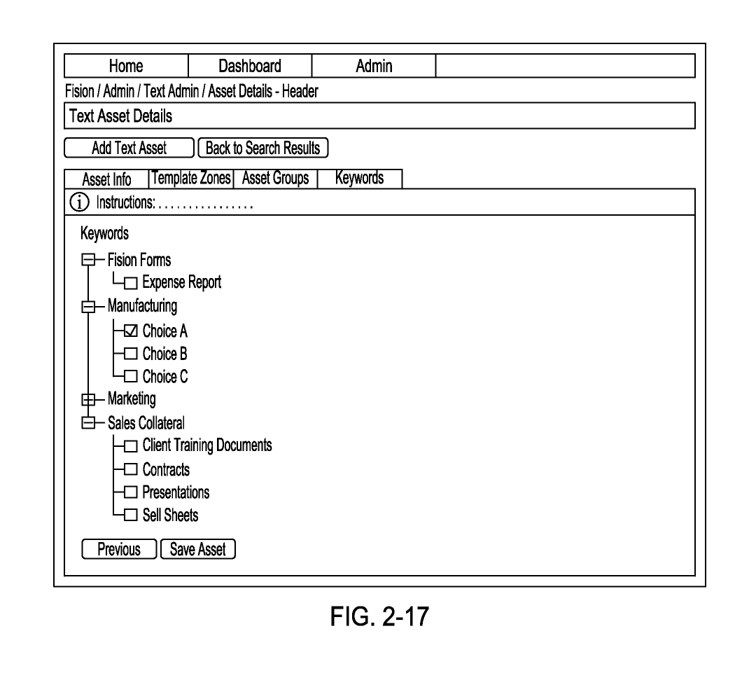

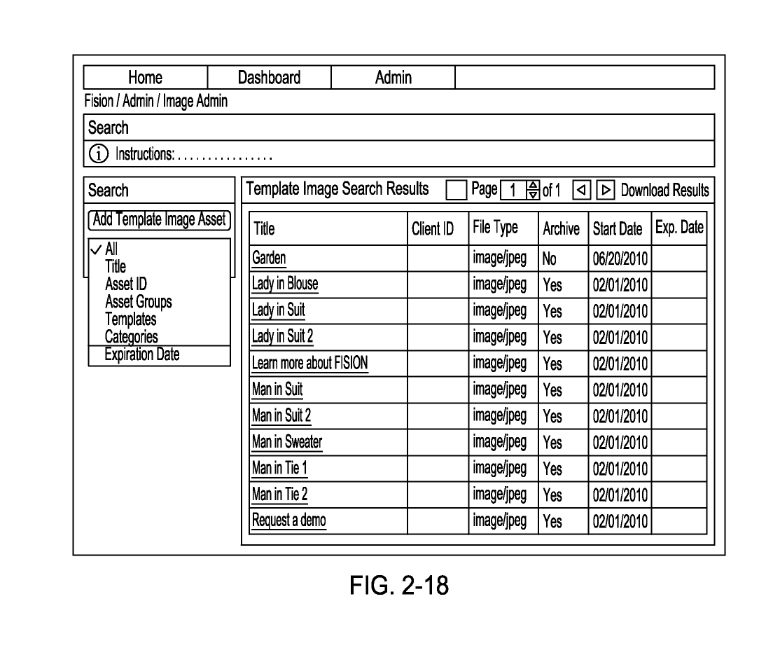

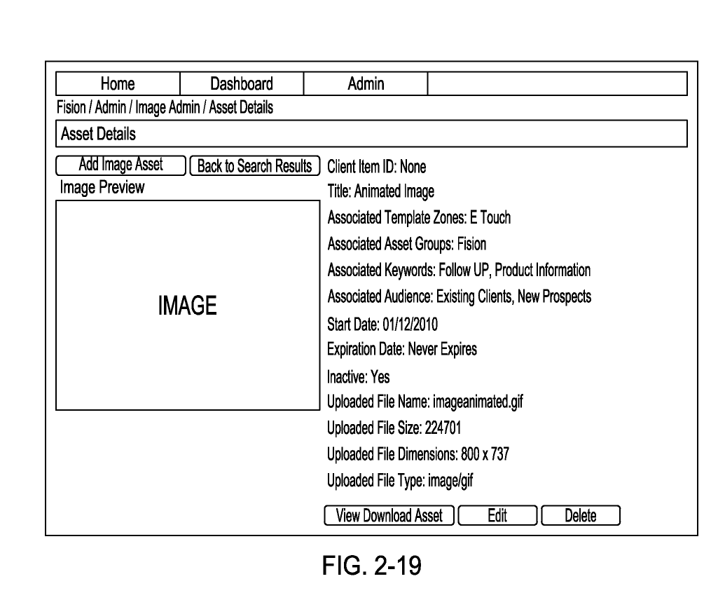

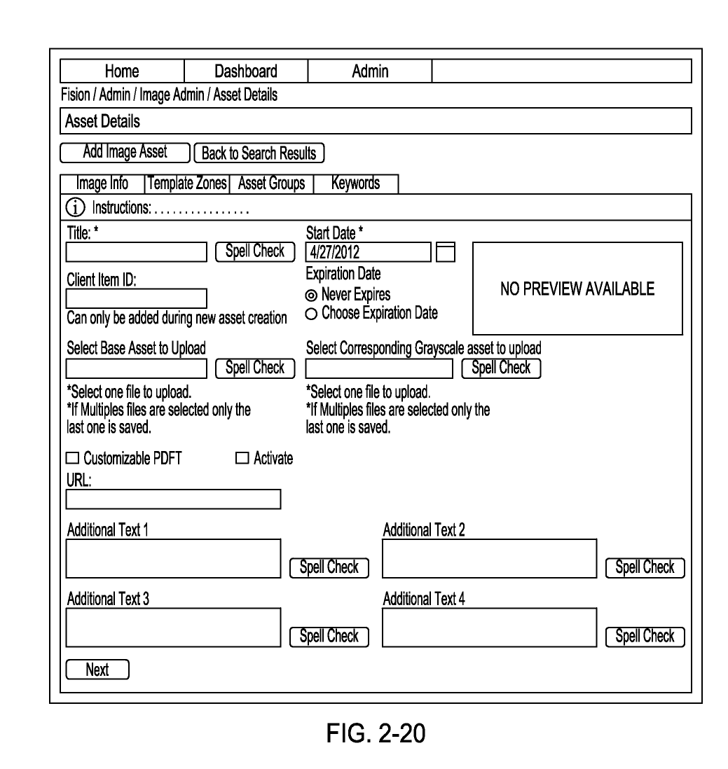

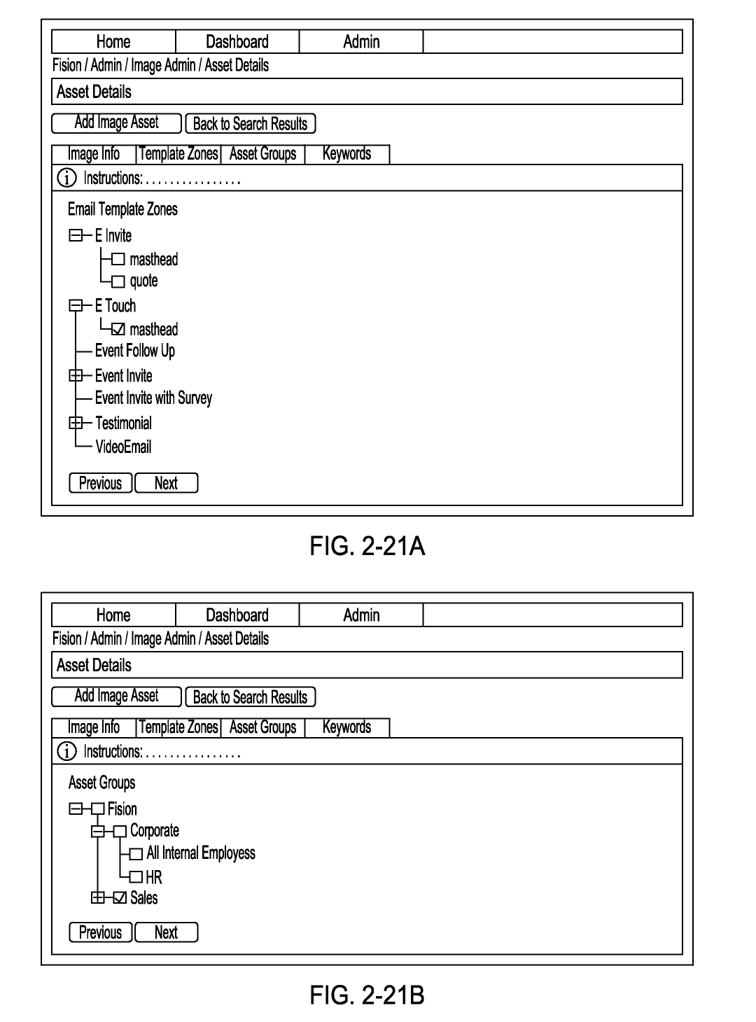

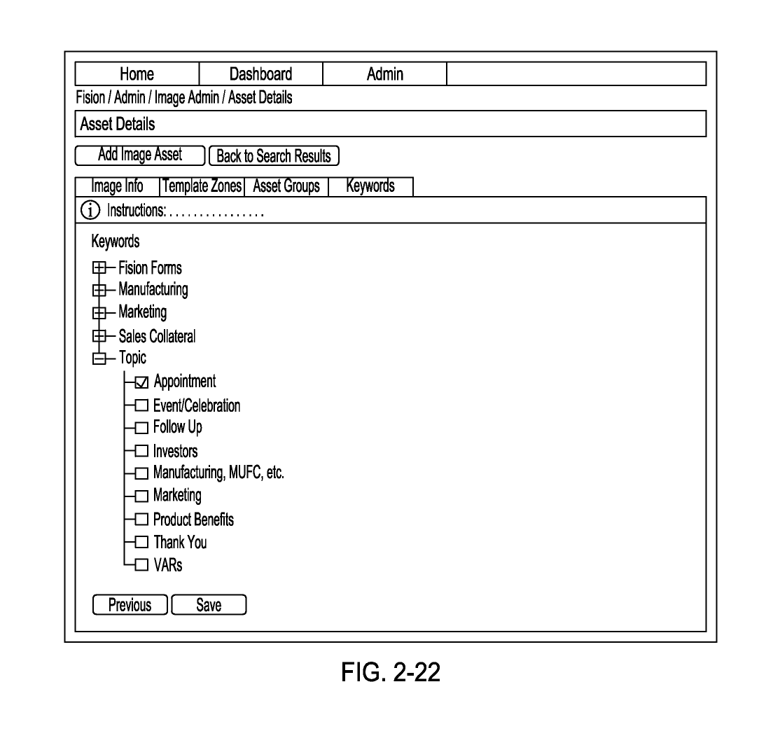

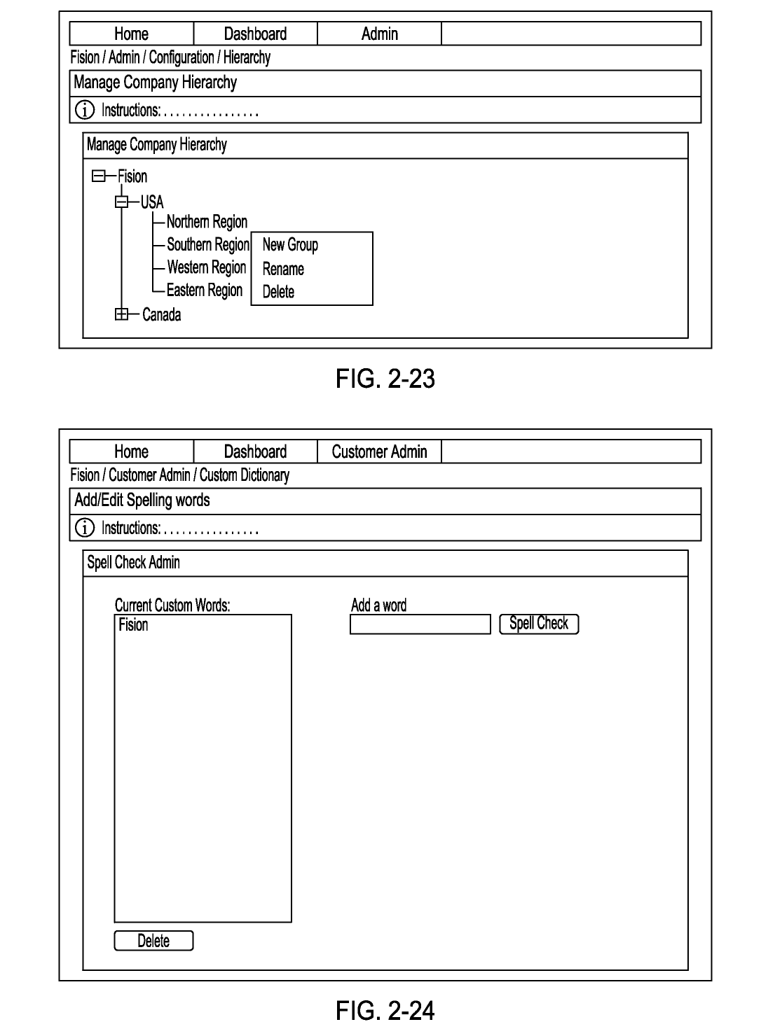

Referring to FIG. 1-2, there is illustrated an overview of the asset management control applied to individual marketing assets 160. Business rules and access privileges 162 may be used to control access to assets 160 on multiple levels or dimensions 164, based on a defined organizational hierarchy, privileges of individuals in that hierarchy, the geographic location of an organization or user, language requirements, local legal rules and regulations, and/or specific restrictions applied to individual assets.

According to one example embodiment illustrated in FIG. 1-3, the system 100 allows for multiple levels of administration of asset management, wherein a first administrative user may establish a group of individuals 174 in a first organization, one or more of which may in turn be authorized to establish one or more subgroups of users 176 and so on to create even lower levels of hierarchy. The privileges of each group and/or individual to use marketing assets in the system may be specified. Accordingly, a first set of marketing assets, for example assets A1 and A2, may be authorized for use by a first group as a whole, but only a portion of that authorization may be passed onto individual members of the group by a person responsible for managing the first group, for example, by individual I-1 who provides access to asset A1. In addition, a member of the first group, having privileges to the first set of marketing collateral, may in turn create his or her own subgroup, and selectively pass the privileges to use individual ones of the first set of assets to individual ones of that subgroup.

Referring to FIG. 1-4, there is illustrated an overview of the various modules of the system 100 used to set up and maintain the system data structures required to support the various functions of the system for users. Modules 180 to 193 accordingly provide both computer program instructions that are executed on a computer platform such as those described in more detail below, and data structures to organize and store data created by or loaded into the system by users, such as configuration data or asset data, such as digital assets.

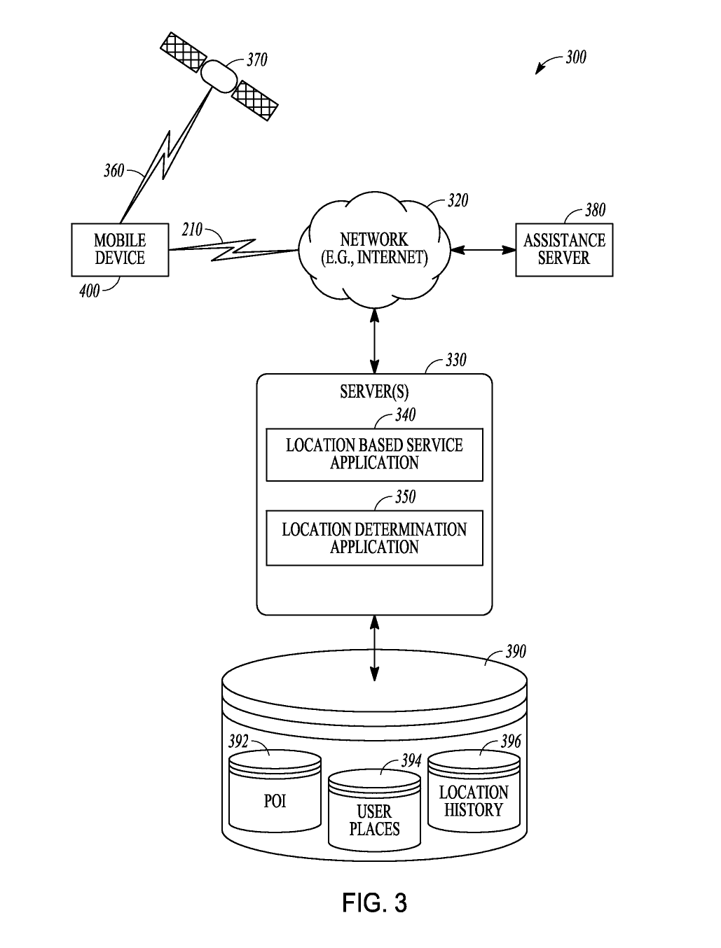

A User Manager module 180, configured to generate a GUI illustrated in FIG. 2-1, allows a user to browse a list of all users or search by their first or last name. A Profile module 182, configured to generate a GUI illustrated in FIG. 2-2, displays basic contact information about a user, and allows for entry of profile information. An Asset Groups module 183, configured to generate a GUI illustrated in FIG. 2-3, allows a user to manage which sets of assets a user is allowed to access Users can belong to one or multiple Asset Groups. A Login Hierarchy module 184, configured to generate a GUI illustrated in FIG. 2-4, identifies the user's place within the company tree of system permissions. An Assign Admin Rights module 185, configured to generate a GUI illustrated in FIG. 2-5, is available to manage admin rights and control access to specific functionality.

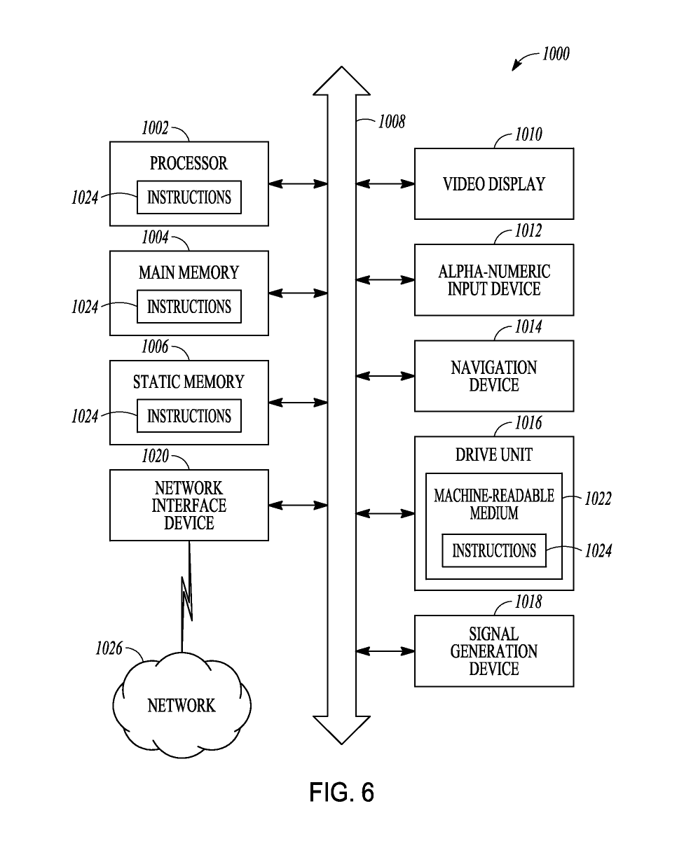

A Print Vendor Admin module 186, illustrated in configured to generate a GUI FIG. 2-6, has the ability to add or edit Print Vendor information stored in the system for user orders. An Asset Group Admin module 187, configured to generate a GUI illustrated in FIG. 2-7, is an organizational function to help manage how a user's assets are stored and who can access them. A Keyword Admin module 188, configured to generate a GUI illustrated in FIG. 2-8, provides that assets are assigned categories in the automated distributed marketing system and then organized into keywords. Organization according to keywords may assist with the search process in the Asset Library or sorting of assets within a customizable template. An Asset Library Admin module 189, configured to generate GUIs illustrated in the FIGS. 2-9 to 2-11, allows admin users to manage assets accessed by users in the Asset Library.

A Text Admin module 190, configured to generate GUIs illustrated in FIGS. 2-12 to 2-17, manages Text Assets which includes headers, greetings, articles, and body copy. An Image Admin module 191, configured to generate GUIs illustrated in FIGS. 2-18 to 2-22, controls Image Assets, which are any files for use in email or PDF customization. These assets make up components of customizable templates to which they are assigned. An Organization Hierarchy module 192, configured to generate a GUI illustrated in FIG. 2-23, is a list of users grouped the way they are structured in the organization. The hierarchy may be utilized for reporting and login structures. A Custom Dictionary module 193, configured to generate a GUI illustrated in FIG. 2-24, allows a user to add words into the system that are specific to a user's organization and may not be recognized in an English dictionary. These words may be brand names, product offerings, etc.

The User Manager module 180 allows a user to browse a list of all users or search by their first or last name.

The Profile module 182 and corresponding GUI displays basic contact information about a user. These details may be used to populate fields in custom email and PDF templates.

According to one example embodiment, the Profile module has a configurable localization setting for each user that allows the administrator to set the language for the user. When the user logs in, the system automatically changes the GUI on either the back-end portal or the front-end portal, depending on which interface the user is accessing, to the language/localization setting for that user.

The Asset Group module 183 allows a user to manage which sets of assets a user is allowed to access. Users can belong to one or multiple Asset Groups. The Asset Group module 183 and corresponding GUI also may allow Admin Users to assign Users access to functionality for the specified Asset Groups.

The Login Hierarchy module 184 illustrated in the module and corresponding GUI may identify the user's place within the company tree of system permissions. The Login Hierarchy tab may display the user's current position in the company tree.

The Assign Admin Rights module 185 and corresponding GUI may manage admin rights and control access to specific functionality. According to one example method, the Admin module and corresponding GUI may grant or take away rights from various users. In an example, an admin may grants a user access control over managing the Asset library, Template Assets, Keywords and Asset Groups for the specified Asset Groups on the left. The Admin may further grant a user access to Login As another user, Drilldown/Summary reports, manage Print vendors and manage the Hierarchy for the specified Hierarchy on the left. These additional permissions further allow a user to manage the Message Center (on the Home screen), manage the Custom Dictionary, and manage Asset Specific Vendors. An admin may further allow the user to grant the same admin rights to others users in their hierarchy.

The Print Vendor Admin module 186 may allow an admin to add or edit Print Vendor information stored in the system for user orders. Some or all vendors entered may be displayed as options for order fulfillment in the My Orders section. Vendors may further be assigned to a hierarchy group.

The Asset Groups Admin module 187 is an organizational function to help manage how a user's assets are stored and who can access them. This module and corresponding GUI may allow a company admin to add, remove or rename the system asset groups.

The Keyword Admin module 188 may be utilized to assign assets categories in the automated distributed marketing system and then organized into keywords. Keywords may assist with the search process in the Asset Library or sorting of assets within a customizable template. Keywords may be added or edited and may be utilized to filter both template options and Asset Library Searches. A user may not be able to remove a keyword or category if assets are assigned to it. A user may manually remove keywords from the asset information before removing the keyword.

The Asset Library Admin module 189 may allow admin users to manage assets accessed by users in the Asset Library. The Asset Librayr Admin module 189 may provide for search filters to search for assets in the Asset Library, display search results, edit assets and asset details, add or delete assets, display asset information, and associate a client identification and/or a keyword with an asset.

The Text Admin module 190 manages Text Assets which may include headers, greetings, articles, and body copy. When customizing emails or PDFs, these assets may be accessed by users in templates. The Text Admin module 190 may edit text assets and/or text asset details, display asset information, set start and expiration dates for assets, activate assets, set asset types, set template zones to control what assets are utilized with respect to what templates, and assign asset groups and keywords. The functions of the Text Admin module 190 may be applied with respect to the Asset Library Admin module 189 or any of a variety of other modules disclosed herein. The Image Admin module 191 controls Image Assets, which are any files for use in email or template customization. These assets make up components of customizable templates to which they are assigned. The Image Admin module 191 may incorporate some or all of the particular functions of the Text Admin module 190 or other modules disclosed herein.

The Organization Hierarchy module 192 is a list of users (indirect and direct) grouped according to a sales, marketing and/or operations process. Users are grouped beneath (in subordinate position to) their respective hierarchy. The list is nested, so the list may show or may be expanded to show independent or direct reports of each user. Hierarchies may be edited, add or renamed, and have new groups added to the hierarchy.

The Custom Dictionary module 193 allows a user to add words into the system that are specific to a user's organization and may not be recognized in a dictionary, whether English-language or non-English language. For instance, such words may be brand names, product offerings, etc.

### Example Operating Environment

FIG. 3 is a block diagram illustrating an environment 300 for operating a mobile device 400, according to an example embodiment, for deploying and/or implementing the distributed marketing automation system and methods described herein. The mobile electronic device 400 may be any of a variety of types of devices, for example a cellular telephone, a personal digital assistant (PDA), a Personal Navigation Device (PND), a handheld computer, a tablet computer, a notebook computer, or other type of movable device. The device 400 may interface via a connection 310 with a communication network 320. Depending on the form of the mobile electronic device 400, any of a variety of types of connections 310 and communication networks 320 may be used. The device 400 may further interface with a satellite 370 via a link 360.

For example, the connection 310 may be Code Division Multiple Access (CDMA) connection, a Global System for Mobile communications (GSM) connection, or other type of cellular connection. Such connection 310 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology. When such technology is employed, the communication network 320 may include a cellular network that has a plurality of cell sites of overlapping geographic coverage, interconnected by cellular telephone exchanges. These cellular telephone exchanges may be coupled to a network backbone, for example, the public switched telephone network (PSTN), a packet-switched data network, or to other types of networks.

In another example, the connection 310 may be Wireless Fidelity (Wi-Fi, IEEE 802.11x type) connection, a Worldwide Interoperability for Microwave Access (WiMAX) connection, or another type of wireless data connection. In such an embodiment, the communication network 320 may include one or more wireless access points coupled to a local area network (LAN), a wide area network (WAN), the Internet, or other packet-switched data network.

In yet another example, the connection 310 may be a wired connection, for example an Ethernet link, and the communication network may be a local area network (LAN), a wide area network (WAN), the Internet, or other packet-switched data network. Accordingly, a variety of different configurations are expressly contemplated.

A plurality of servers 330 may be coupled via interfaces to the communication network 320, for example, via wired or wireless interfaces. These servers 330 may be configured to provide various types of services to the mobile electronic device 400. For example, one or more servers 330 may execute location based service (LBS) applications 340, which interoperate with software executing on the device 400, to provide LBS's to a user. LBS's can use knowledge of the device's location, and/or the location of other devices, to provide location-specific information, recommendations, notifications, interactive capabilities, and/or other functionality to a user. Knowledge of the device's location, and/or the location of other devices, may be obtained through interoperation of the device 400 with a location determination application 350 executing on one or more of the servers 330. Location information may also be provided by the device 400, without use of a location determination application, such as application 350. In certain examples, the device 400 may have some limited location determination capabilities that are augmented by the location determination application 350. The servers are coupled to database 190, which includes point of interest files 192, user place files 194, and location history files 196.

### Example Mobile Device

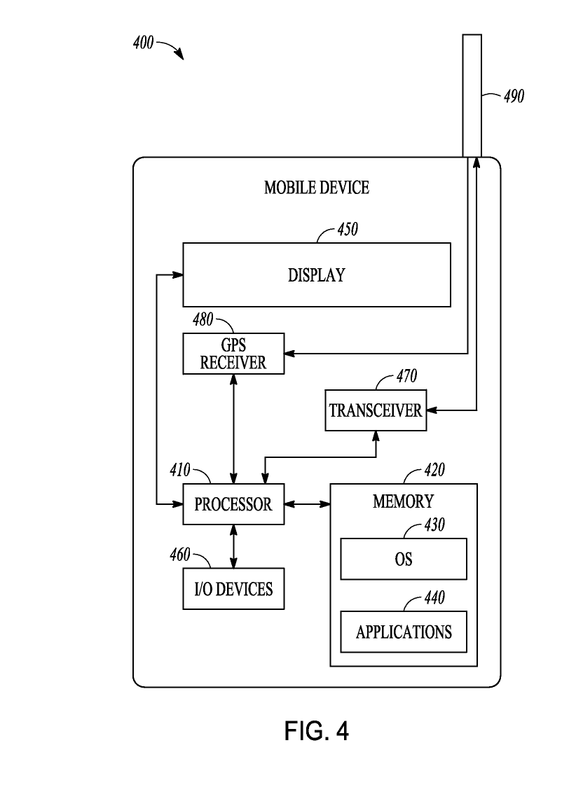

FIG. 4 is a block diagram illustrating the mobile device 400, according to an example embodiment, for deploying and/or implementing the distributed marketing automation system and methods described herein. The device 400 may include a processor 410. The processor 410 may be any of a variety of different types of commercially available processors suitable for mobile devices, for example, an XScale architecture microprocessor, a Microprocessor without Interlocked Pipeline Stages (MIPS) architecture processor, or another type of processor. A memory 420, such as a Random Access Memory (RAM), a Flash memory, or other type of memory, is typically accessible to the processor. The memory 420 may be adapted to store an operating system (OS) 430, as well as application programs 440, such as a mobile location enabled application that may provide LBS's to a user. The processor 410 may be coupled, either directly or via appropriate intermediary hardware, to a display 450 and to one or more input/output (I/O) devices 460, such as a keypad, a touch panel sensor, a microphone, etc. Similarly, in some embodiments, the processor 410 may be coupled to a transceiver 470 that interfaces with an antenna 490. The transceiver 470 may be configured to both transmit and receive cellular network signals, wireless data signals, or other types of signals via the antenna 490, depending on the nature of the device 400. In this manner, the connection 410 with the communication network 420 may be established. Further, in some configurations, a GPS receiver 480 may also make use of the antenna 490 to receive GPS signals.

### Example Platform Architecture

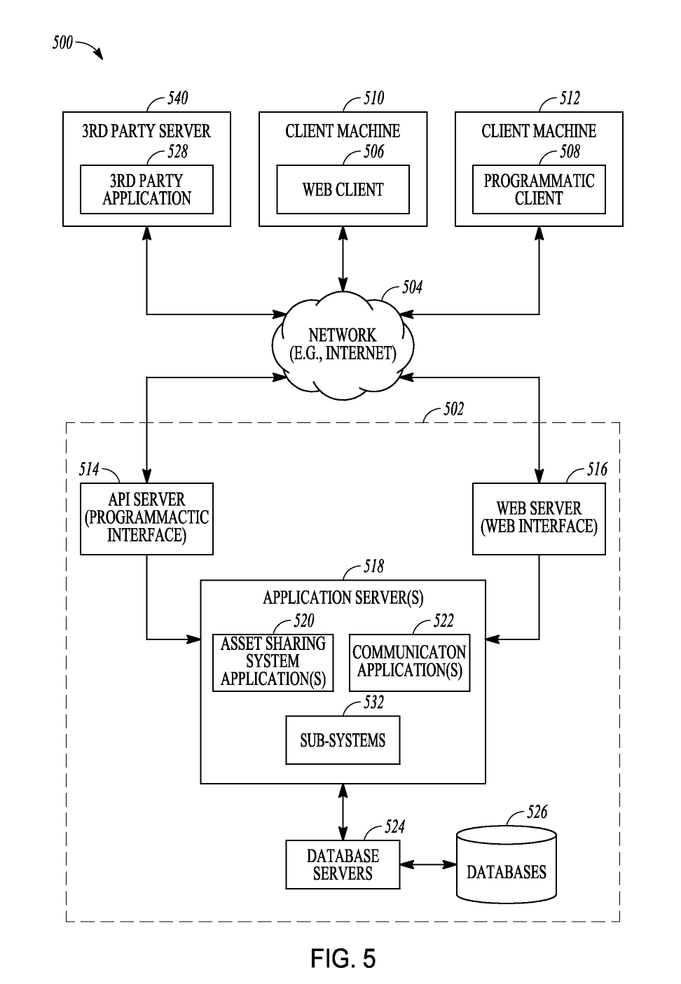

FIG. 5 is a block diagram illustrating a network-based system 500 for deploying and/or implementing the distributed marketing automation system and methods described herein. In an embodiment, the system operates in real time or near real-time. The block diagram depicting a client-server system 500, within which an example embodiment can be deployed is described. A networked system 502, in the example forms a network-based distributed marketing automation system, provides server-side functionality, via a network 504 (e.g., the Internet or Wide Area Network (WAN)) to one or more clients 510, 512. FIG. 5 illustrates, for example, a web client 506 (e.g., a browser, such as the Internet Explorer browser developed by Microsoft Corporation of Redmond, Wash. State), and a programmatic client 508 (e.g., WHERE smartphone application from Where, Inc. of Boston, Mass.) executing on respective client machines 510 and 512. In an example, the client machines 510 and 512 can be in the form of a mobile device, such as mobile device 400.

An Application Programming Interface (API) server 514 and a web server 516 are coupled to, and provide programmatic and web interfaces respectively to, one or more application servers 518. The application servers 518 host one or more distributed marketing automation applications 520 (in certain examples these computer program components are those described herein for the distributed marketing automation system), communication applications 522, and other sub-systems 532. The application servers 518 are, in turn, shown to be coupled to one or more database servers 524 that facilitate access to one or more databases 526. In some examples, the application server 518 can access the databases 526 directly without the need for a database server 524.

The distributed marketing automation applications 520 may provide a number of distributed marketing automation functions and services to users that access the networked system 502, as described otherwise herein. The communication applications 522 may likewise provide a number of communication services and functions to users, for example to interface with and send messages and data between various communication applications, including e-mail services, text messaging services, instant messaging services, or other communication services, such as messaging through social media platforms. While the distributed marketing automation applications 520 and communication applications 522, and other sub-systems 532 are shown in FIG. 5 to all form part of the networked system 502, it will be appreciated that, in alternative embodiments, the applications 520 and 522 or others may form part of a service that is separate and distinct from the networked system 502.

Further, while the system 500 shown in FIG. 5 employs a client-server architecture, the present invention is of course not limited to such an architecture, and could equally well find application in a distributed, or peer-to-peer, architecture system, for example. The various applications 520, applications 522, and sub-system 532 could also be implemented as standalone software programs, which do not necessarily have networking capabilities.

The web client 506 accesses the various distributed marketing automation applications 520, communication applications 522, and optional sub-systems 532 via the web interface supported by the web server 516. Similarly, the programmatic client 508 accesses the various services and functions provided by the applications, servers 520, 522 and 532 via the programmatic interface provided by the API server 514. The programmatic client 508 may, for example, be a local recommendation smartphone application (e.g., the WHERE application developed by Where, Inc., of Boston, Mass.) to enable users to receive real-time location-aware merchant promotions on their smartphones leveraging user profile data and current location information provided by the smartphone.

FIG. 5 also illustrates a third party application 528, executing on a third party server machine 540, as having programmatic access to the networked system 502 via the programmatic interface provided by the API server 514. For example, the third party application 528 may, utilizing information retrieved from the networked system 502, support one or more features or functions on a website hosted by the third party. The third party website may, for example, provide one or more functions that are supported by the relevant applications of the networked system 502.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 10 is a block diagram of a machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for computer guided distributed marketing automation have been described. Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a network interface, communicatively coupled to a first client machine and a second client machine, the first client machine associated with a first user having a first language/location setting corresponding to a first language and the second client machine associated with a second user having a second language/location setting corresponding to a second language; and
an electronic data storage configured to store a marketing asset in a marketing asset language; and
a processor, coupled to the electronic data storage and the network interface, configured to:
upon receiving a first command to transmit the marketing asset to the first client machine, causing, via the network interface, a graphical user interface to be displayed on the first client machine in the first language and the marketing asset to be displayed with respect to the graphical user interface, wherein the marketing asset is displayed only when the marketing asset language corresponds to the first language; and
upon receiving a second command to transmit the marketing asset to the second client machine, causing, via the network interface, the graphical user interface to be displayed on the second client machine in the second language and the marketing asset to be displayed with respect to the graphical user interface, wherein the marketing asset is displayed only when the marketing asset language corresponds to the second language.

2. The system of claim 1, wherein the graphical user interface corresponds to a third language different from the first language and the second language and wherein the processor is further configured to dynamically translate the graphical user interface from the third language to the first language and the second language upon receiving the first and second commands, respectively.

3. The system of claim 2, wherein the processor is further configured to access a language translation service remote to the processor to translate the marketing graphical user interface from the third language to the first language and the second language.

4. The system of claim 1, wherein the electronic data storage is further configured to store the graphical user interface in the first language and in the second language and wherein the processor is configured to transmit the graphical user interface to the first client machine by accessing the graphical user interface from the electronic data storage in the first language and transmit the graphical user interface in the second language by accessing the graphical user interface from the electronic data storage in the second language.

5. The system of claim 4, wherein the graphical user interface is configured to be updated and wherein the graphical user interface is stored, upon being updated, in the first language and in the second language as updated.

6. The system of claim 1, wherein the marketing asset language corresponds to the first language and the second asset language when the marketing asset language is the same as the first language and the second language, respectively.

7. The system of claim 1, wherein the first language/location setting further comprises a first location associated with the first user and the second language/location further comprises a second location associated with the second user, wherein the marketing asset has a location tag, and wherein the processor is configured to cause the marketing asset to be displayed with respect to the graphical user interface as displayed on the first client machine only if the location tag further matches the first location and with respect to the graphical user interface as displayed on the second client machine only if the location tag further matches the second location.

8. A processor-implemented system, comprising:
a profile manager module including a first language/location setting corresponding to a first language of a first user and a second language/location setting corresponding to a second language of a second user; and
a marketing material repository module to store a marketing asset in a marketing asset language; and
a services module, coupled to the profile manager module and the marketing material repository module, configured to:
upon receiving a first command to transmit the marketing asset to the first client machine, causing a graphical user interface to be displayed on the first client machine in the first language and the marketing asset to be displayed with respect to the graphical user interface, wherein the marketing asset is displayed only when the marketing asset language corresponds to the first language; and
upon receiving a second command to transmit the marketing asset to the second client machine, causing the graphical user interface to be displayed on the second client machine in the second language and the marketing asset to be displayed with respect to the graphical user interface, wherein the marketing asset is displayed only when the marketing asset language corresponds to the second language.

9. The system of claim 8, wherein the graphical user interface corresponds to a third language different from the first language and the second language and wherein the services module is further configured to dynamically translate the graphical user interface from the third language to the first language and the second language upon receiving the first and second commands, respectively.

10. The system of claim 9, wherein the services module is further configured to access a language translation service remote to the services module to translate the marketing graphical user interface from the third language to the first language and the second language.

11. The system of claim 8, wherein the marketing material repository module is further configured to store the graphical user interface in the first language and in the second language and wherein the services module is configured to transmit the graphical user interface to the first client machine by accessing the graphical user interface from the marketing material repository module in the first language and transmit the graphical user interface in the second language by accessing the graphical user interface from the marketing material repository module in the second language.

12. The system of claim 11, wherein the graphical user interface is configured to be updated and wherein, upon being updated, the graphical user interface is stored in the first language and in the second language as updated.

13. The system of claim 8, wherein the marketing asset language corresponds to the first language and the second asset language when the marketing asset language is the same as the first language and the second language, respectively.

14. The system of claim 8, wherein the first language/location setting further comprises a first location associated with the first user and the second language/location further comprises a second location associated with the second user, wherein the marketing asset has a location tag, and wherein the services module is configured to cause the marketing asset to be displayed with respect to the graphical user interface as displayed on the first client machine only if the location tag further matches the first location and with respect to the graphical user interface as displayed on the second client machine only if the location tag further matches the second location.

15. A computer readable medium comprising instructions that, when implemented on a processor, cause the processor to:
upon receiving a first command to transmit a marketing asset to a first client machine, cause:
a graphical user interface to be displayed on the first client machine in a first language of a first language/location setting associated with a first user; and
the marketing asset to be displayed with respect to the graphical user interface, wherein the marketing asset is displayed only when a marketing asset language of the marketing asset corresponds to the first language; and
upon receiving a second command to transmit the marketing asset to a second client machine, cause:
the graphical user interface to be displayed on the second client machine in a second language of a second language/location setting associated with a second user; and
the marketing asset to be displayed with respect to the graphical user interface, wherein the marketing asset is displayed only when the marketing asset language corresponds to the second language.

16. The method of claim 15, wherein the graphical user interface corresponds to a third language different from the first language and the second language and further comprising dynamically translating the graphical user interface from the third language to the first language and the second language upon receiving the first and second commands, respectively.

17. The method of claim 16, wherein dynamically translating comprises accessing a language translation service to translate the marketing graphical user interface from the third language to the first language and the second language.

18. The method of claim 15, further comprising storing the graphical user interface in the first language and in the second language and wherein displaying the graphical user interface on the first client machine by accessing the graphical user interface in the first language and displaying the graphical user interface in the second language by accessing the graphical user interface from the marketing material repository module in the second language.

19. The method of claim 18, wherein the graphical user interface is configured to be updated and wherein, upon being updated, the graphical user interface is stored in the first language and in the second language as updated.

20. The method of claim 15, wherein the marketing asset language corresponds to the first language and the second asset language when the marketing asset language is the same as the first language and the second language, respectively.

21. The method of claim 15, wherein the first language/location setting further comprises a first location associated with the first user and the second language/location further comprises a second location associated with the second user, wherein the marketing asset has a location tag, and wherein displaying the marketing asset with respect to the graphical user interface as displayed on the first client machine occurs only if the location tag further matches the first location and with respect to the graphical user interface as displayed on the second client machine occurs only if the location tag further matches the second location.
